(19) United States
(12) Patent Application Publication
(10) Pub. No.: US 2026/0208455 A1
(43) Pub. Date: Jul. 23, 2026

(54) FILAMENT WINDING METHOD, FILAMENT WINDING DEVICE AND FILAMENT WINDING MACHINE

(71) Applicant: Dietze & Schell Maschinenfabrik GmbH & Co. KG, Coburg (DE)

(72) Inventors: Johannes BOUILLON, Coburg (DE); Björn FRÖTSCHNER, Lautertal (DE); René HACK, Coburg (DE)

(21) Appl. No.: 19/140,270

(22) PCT Filed: Dec. 20, 2023
(86) PCT No.: PCT/EP2023/087018

§ 371 Date: Jun. 17, 2025

(30) Foreign Application Priority Data
Dec. 23, 2022 (DE) 10 2022 134 699.4

(51) Int. Cl. B29C 70/56; B29C 70/30; B29K 309/08

(52) U.S. Cl. CPC B29C 70/56; B29C 70/30; B29K 2309/08

(57) ABSTRACT

A filament winding method includes at least one filament capture step in which a filament is captured by a filament capturing unit that generates at least one tensile force on the filament and conveys the filament at a first conveying speed, and at least one initial filament winding step, in which the filament is wound onto a winding spool unit.

In the filament winding step, the captured filament is brought into contact upstream with the rotated winding spool unit, such that a second conveying speed is exerted on the captured filament. The first and second conveying speeds are of different magnitudes. A ratio of the first and second conveying speeds is selected so the filament forms a loop whose arc points in an entry point direction of the winding spool unit at which the incoming filament provided by a filament generating device meets the winding spool unit.

### CROSS-REFERENCE TO RELATED APPLICATIONS

This patent application is a U.S. national stage application of international patent application PCT/EP2023/087018, filed on Dec. 20, 2023, which is based on and claims priority to German patent application DE 10 2022 134 699.4, filed on Dec. 23, 2022, the contents of which are incorporated herein by reference.

### PRIOR ART

The invention relates to a filament winding method, a filament winding device and a filament winding machine.

Glass fiber winders are already known.

For example, a filament winding method for filaments is already known from U.S. Pat. No. 3,539,317 A.

From CN 110 550 499 A and EP 0 032 904 B1 filament winding methods for filaments having a thickness of more than 68 tex are already known, wherein the known filament winding methods comprise at least one filament capturing step, in which the provided filament is captured by a filament capturing unit, which generates at least one tensile force onto the filament and conveys the filament at a first conveying speed, and comprise at least one initial filament winding step, in which the filament to be wound is initially wound onto a winding spool unit.

The object of the invention is in particular to provide a generic device with advantageous properties with regard to winding a new filament onto a winding spool unit for winding the filament. The object is achieved according to the invention

### Advantages of the Invention

The invention is based on a filament winding method, in particular a glass fiber winding method, for filaments with a thickness of more than 68 tex, preferably for glass fiber direct rovings, with at least one filament capture step, in which the, in particular freely hanging, provided, in particular generated, filament is captured by a filament capture unit, which generates at least one tensile force on the filament and conveys the filament at a first conveying speed, and with at least one initial filament winding step, in which the filament to be wound is initially wound onto a winding spool unit, wherein in the initial filament winding step, the filament already captured by the filament capturing unit is brought into contact upstream of the filament with the rotated winding spool unit, such that a second conveying speed is exerted on the captured filament by the rotation of the winding spool unit, wherein the first conveying speed and the second conveying speed are of different magnitudes.

It is proposed that a ratio of the second conveying speed and the first conveying speed is selected such that, as a result of the contact and as a result of the rotational movement of the winding spool unit, the filament forms a loop whose arc points in the direction of an entry point of the winding spool unit at which the incoming filament/the filament provided by a filament generating device meets the winding spool unit. A simple, rapid and/or operator-independent initial filament winding can advantageously be achieved as a result. Capturing and/or clamping of the filament on the winding spool unit, in particular by the incoming filament/the filament provided by the filament generating device, can advantageously be made possible as a result, with the result that initial winding of the filament onto the winding spool unit begins automatically. In particular, the loop is embodied as an open loop whose open side is oriented so as to point at least substantially away from the incoming filament. In particular, the loop is initially oriented so as to be upright as viewed relative to a surface of the winding spool unit. When the loop becomes larger, it preferably falls over and then lies as a flat arc on the winding spool unit or on a winding tube placed onto the winding spool unit. As a result, the loop can be captured particularly simply and/or reliably by the incoming thread, in particular since it does not come to lie to the right or to the left of the incoming thread. An optimized filament winding of a new filament onto a winding spool unit can advantageously be achieved by the filament winding method according to the invention. A substantial independence from the necessity of operator interventions can advantageously be achieved. A particularly high degree of automation can advantageously be achieved. In particular, the filament is embodied as a glass fiber. In particular, the filament winding method is carried out directly after or in temporal connection with the generation of the filaments, in particular glass fibers. In this case, it may occur that the filaments to be wound, in particular glass fibers, are still moist during the winding and/or during the carrying out of the initial filament winding step. In particular, the filament simultaneously contacts the filament capture unit and the winding spool unit at least temporarily in the initial filament winding step. In particular, the initially freely hanging filament just generated is received in the initial filament winding step by a winding spool unit, which is initially free of filament windings, in particular in such a way that, after the initial filament winding step, the filament just generated is wound onto the winding spool unit directly by a filament generating device arranged above the winding spool unit. In particular, the filament winding method is configured for filaments with a thickness of more than 68 tex, preferably more than 300 tex, but an application of the filament winding method according to the invention for filaments with a thickness of less than 68 tex or of less than 300 tex is thereby not excluded or likewise possible.

In particular, the winding spool unit is rotatable, preferably rotationally driven, for example by a drive unit. It is conceivable for the winding spool unit to be part of a filament winding device with a plurality of winding spool units. Preferably, a conveying speed, rotational speed, revolution speed and/or outer circumferential speed of the winding spool unit is adjustable. In particular, the conveying speed, rotational speed, revolution speed and/or outer circumferential speed of the winding spool unit is adjustable separately from the further winding spool units. In particular, the conveying speed, rotational speed, revolution speed and/or outer circumferential speed of the winding spool unit is adjustable separately from a conveying speed, rotational speed, revolution speed and/or outer circumferential speed of the filament capture unit. For example, the rotational speed of the winding spool unit and/or of the filament capture unit can be individually reduced or increased, preferably braked or accelerated.

The winding spool unit is preferably embodied in a cylindrical shape. It is conceivable for a plurality of separate, for example two, filament winding packages to be produced per winding spool unit. In this case, the plurality of filament winding packages are arranged next to one another on the winding spool unit in the axial direction of the winding spool unit. In particular, the two winding spool units are embodied substantially differently from the filament capture unit. It is conceivable for the filaments to be wound directly onto a surface of the winding spool unit, but preferably one winding tube is applied, e.g. fitted, onto the winding spool unit per filament winding package, onto which winding tube the respective filament is then wound. Preferably, the filament capture unit is free of winding tubes. In particular, the filament is fed to the winding spool unit and/or to the filament capture unit via a filament feed device. The filament has a thickness of more than 68 tex, in particular more than 300 tex, preferably more than 900 tex. Preferably, the filament is embodied as a direct roving, which in particular has a thickness of 900 tex to 10,000 tex. In this case, a “tex” is intended to be understood in particular to mean a weight in grams per 10,000 m of filament. In particular, such filaments, in particular direct rovings, are not suitable for direct winding onto a winding spool unit, as may possibly be the case in the so-called spinning cake method. This functions in particular only in the case of filaments with thicknesses below 68 tex.

“Configured” is intended to be understood in particular to mean specially programmed, designed and/or equipped. The fact that an object is configured for a specific function is intended to be understood in particular to mean that the object fulfills and/or carries out this specific function in at least one use state and/or operating state.

For example, the provided filament is produced by a filament production device in a so-called drawing tower. However, other production methods are also conceivable. In this case, a starting material is melted until at least one drop, in particular glass drop, is produced, which drop is drawn vertically downward by gravity and in the process draws a thin fiber (the filament). In particular, the drop and/or the drawn-up fiber is/are clamped in by the filament capture unit during capture. In particular, the filament capture unit draws on the drawn-up fiber. Preferably, a diameter of the filament is determined in this case by the respective effective conveying speed of the filament capture unit (first) and/or of the winding spool unit (later). In particular, the tensile force generated by the filament capture unit acts parallel to a direction of gravity, which preferably likewise runs parallel to a longitudinal extent of the provided filament. In particular, the term “upstream of the filament” is intended to be understood to mean toward a point of origin of the filament, preferably toward a filament production source. Alternatively, bringing the filament into contact with the winding spool unit downstream of the filament capture unit is also conceivable. In this case, the speed ratio of the conveying speeds would possibly have to be reversed. In particular, in the initial filament winding step, a newly generated filament is wound onto a winding spool unit for the first time. In particular, the rotated winding spool unit at least partially draws the filament along with the rotational movement of the winding spool unit after contact has been established. In particular, the first conveying speed and the second conveying speed differ by at least 1%, preferably by at least 2%. Greater conveying speed differences, e.g. more than 10%, more than 20% or more than 30%, are of course likewise conceivable. In particular, the first conveying speed and/or the second conveying speed can be at least substantially identical to an, in particular radial, outer circumferential speed of the respective winding spool unit or filament capture unit. In particular, an “outer circumferential speed”, preferably a “radial outer circumferential speed”, is intended to be understood to mean a movement speed and/or an angular speed of a point which is intended to be understood on a radial outer surface of the respective element of the winding spool unit or of the filament capture unit which lies radially furthest out and comes into contact with the filament. In particular, the winding spool unit comprises at least one winding spool holder and/or at least one winding tube holder or is preferably embodied as the latter. In particular, the winding spool unit is embodied as a winding mandrel. In particular, the filament capture unit forms a filament pulling unit.

Furthermore, it is proposed that the second conveying speed is greater than the first conveying speed. A simple, rapid and/or operator-independent filament transfer from the filament capture unit to the winding spool unit can advantageously be achieved as a result. The reduction of the filament tension in the region between the winding spool unit and the filament capture unit and/or the lengthening of the filament in the region between the winding spool unit and the filament capture unit can advantageously be achieved as a result.

Furthermore, it is proposed that a ratio of the conveying speeds is selected such that, when bringing the filament into contact with the winding spool unit, a filament tension between the winding spool unit and the filament capture unit is reduced. A simple, rapid and/or operator-independent filament winding can advantageously be achieved as a result. A formation of a loop which can be captured and/or clamped by a fed part of the filament can advantageously be conveyed as a result, with the result that winding onto the winding spool unit begins automatically. In particular, sagging or an excess length of the filament in the region between the winding spool unit and the filament capture unit is produced by the reduction of the filament tension in the region between the winding spool unit and the filament capture unit, as a result of which it is possible for the filament to be carried along by the winding spool unit over an outer circumferential section of the winding spool unit of more than 180°. In particular, as a result of the reduction of the filament tension in the region between the winding spool unit and the filament capture unit, a total length of a section of the filament which is not in contact with the winding spool unit and is arranged at the same time in the region between the winding spool unit and the filament capture unit increases to a value which is greater than a shortest distance between the winding spool unit and the filament capture unit, in particular between the respective filament contact points of the winding spool unit and the filament capture unit, at which points the filament lifts off the winding spool unit or the filament capture unit.

If a ratio of the second conveying speed and the first conveying speed is at least 1.01, preferably at least 1.02 and preferably at least 1.03, an optimum filament tension reduction and/or an optimum filament lengthening in the region between the winding spool unit and the filament capture unit can advantageously be achieved. Greater ratios, e.g. more than 1.1, more than 1.2 or more than 1.3, are of course likewise conceivable. In principle, a ratio>1 but <1.01 could also be sufficient in certain cases for maintaining the advantageous effect (loop).

If, in addition, a ratio of the second conveying speed and the first conveying speed is at most 5, preferably at most 4 and preferably at most 3.5, an optimum filament tension reduction and/or an optimum filament lengthening in the region between the winding spool unit and the filament capture unit can advantageously be achieved. Particularly preferably, the ratio of the conveying speeds during the transfer of the filament from the filament capture unit to the winding spool unit is at most 1.3. In particular, for generating the conveying speed ratio, the winding spool unit is accelerated relative to the free filament capture unit or vice versa.

In addition, it is proposed that the formation of the loop is assisted by a blowing device and/or by a spraying device. A high reliability of the filament winding can advantageously be achieved as a result. Capturing and/or clamping of the loop by the incoming filament/the filament provided by the filament generating device can advantageously be accelerated. In particular, the blowing device is configured for outputting a gaseous medium, such as blowing air or another gaseous blowing medium, for example nitrogen. In particular, the spraying device is configured for outputting a liquid medium, such as for example water or another liquid spraying medium. For example, it is conceivable for the spraying device to be configured for outputting an adhesive, which is intended in particular to intensify the adherence of the filament to the winding spool unit by adhesion, or a liquid nitrogen, which is intended in particular to intensify the adherence of the filament to the winding spool unit by freezing. In particular, the blowing device and/or the spraying device is/are oriented such that an output direction of the blowing medium and/or of the spraying medium points at least substantially toward the open side of the loop and/or points into the loop. In particular, a blowing direction/spraying direction of the blowing device/spraying device points in the direction of the entry point of the winding spool unit at which the incoming filament/the filament provided by the filament generating device meets the winding spool unit. In particular, the blowing device/spraying device is in this case arranged on a side of the filament which is opposite the side of the filament on which the entry point of the winding spool unit lies. In particular, the blowing device and/or the spraying device assists the formation of the loop by the stress-reduced filament being moved in the direction of a surface of the free winding spool unit. In particular, the blowing device and/or the spraying device assists the formation of the loop by a part of the stress-reduced filament being moved more strongly in the direction of the incoming filament/the filament provided by the filament generating device than the adjoining parts of the filament, as a result of which, in particular, a concave curvature of the filament as viewed from the blowing device and/or the spraying device is produced. In particular, the blowing device and/or the spraying device assists the formation of the loop by an initially produced loop being enlarged by the blowing and/or spraying. In particular, the blowing device and/or the spraying device assists the formation of the loop by the formation of the loop being accelerated by the blowing and/or spraying.

Furthermore, it is proposed that the formation of the loop is assisted by a choice of a winding surface material and/or a topographical winding surface property of a winding surface of the winding spool unit, of a winding surface of a winding tube fitted onto the winding spool unit or of a catching surface of the winding spool unit, in particular of a catching ring, arranged laterally next to the winding surface of the winding spool unit or of the winding tube. A high reliability of the filament winding can advantageously be achieved as a result (high “catching rates”). Capturing and/or clamping of the loop by the incoming filament/the filament provided by the filament generating device can advantageously be accelerated. In particular, a material with good adhesion properties for glass fibers, for example aluminum, hard-anodized aluminum, stainless steel, coated stainless steel, plastic or leather, is selected as the winding surface material. In particular, a surface property with an increased friction with glass fibers, for example a surface of a woven fiber glass ribbon, a surface of a hook and loop ribbon, a surface of a sand paper, a corrugated surface or an extremely smooth-polished surface, is selected as the topographical winding surface property. In particular, the winding tube is embodied as a hollow cylinder. In particular, the winding tube is configured to carry the filament and to provide it for subsequent further processing. In particular, the catching surface is configured to provide a surface with an increased friction and/or adhesion for the filament, preferably in comparison with a surface of the already wound-up filament, such that a filament contacting the catching surface is at least partially entrained with a rotational movement of the catching surface. In particular, the catching surface can likewise have the winding surface materials and/or topographical winding surface properties described above. Preferably, the catching surface is arranged between two adjacent winding tubes fitted onto the winding spool unit. In particular, the catching surface separates two winding tubes arranged axially next to one another on a winding spool unit. In particular, in this case, the winding spool unit has a catching ring which runs around a circumference of the winding spool unit and provides the catching surface.

If the loop extends so far in the direction of the entry point that the loop falls under the incoming filament and is preferably clamped by the incoming filament/the filament provided by the filament generating device, a high reliability of the filament winding can advantageously be achieved (high “catching rates”). In particular, the loop firstly enlarges in an upright orientation in the direction of the incoming filament and then tilts over such that it lies as a flat arc on a winding region of the winding spool unit or of a winding tube placed onto the winding spool unit, with the result that adjoining windings of the filament run over the tilted-over arc and clamp the latter. In particular, the loop is clamped by the incoming filament/the filament provided by the filament generating device such that the loop is also clamped and remains under filament windings formed subsequently on the winding spool unit. In particular, the loop is clamped by the incoming filament such that, as a result of the rotation of the winding spool unit on which the loop is clamped, a tension is produced on that part of the filament which is arranged in an intermediate region between the winding spool unit and the filament catching unit. In particular, the loop is clamped by the incoming filament such that the winding spool unit and the filament catching unit exert a tension acting in respectively opposite directions on that part of the filament which is arranged between the winding spool unit and the filament catching unit.

Furthermore, it is proposed that, in at least one filament separating step following the initial filament winding step, the initially wound filament is separated, preferably torn or cut, in the intermediate region, in particular on account of different directions of tension on the filament in an intermediate region between the winding spool unit and the filament catching unit. A particularly simple, effective and/or low-maintenance separation of the filament after successful initial winding can advantageously be achieved as a result. Preferably, the tearing takes place exclusively on account of the tensile forces on the filament in the intermediate region which are generated by the rotation of the winding spool unit and by the rotation of the filament catching unit. Alternatively, however, it is also conceivable for the separating step to be assisted by tearing edges or cutting devices, in particular arranged in the intermediate region. The cutting device could be configured for passive cutting (cutting/knives remain unmoved in the filament separating step) or for active cutting (cutting/knives are moved in the filament separating step) of the filament in the intermediate region. In particular, cutting and/or tearing of the filament in the intermediate region takes place only when the loop is already successfully clamped under the incoming filament/the filament provided by the filament generating device and therefore, in particular, the winding of the filament onto the winding spool unit (the initial filament winding step) has already taken place.

Furthermore, it is proposed that, in the initial filament winding step, when bringing the filament into contact with the winding spool unit, an incoming part of the filament and/or a part of the filament running between the winding spool unit and the filament capturing unit is deflected in the direction of the winding spool unit by a pivotably and/or displaceably supported deflection and/or pressing-on element. A high reliability of the filament winding can advantageously be achieved as a result (high “catching rates”). Capturing and/or clamping of the loop by the incoming filament/the filament provided by the filament generating device can advantageously be accelerated. In particular, a proportion of a circumference of the winding spool unit which is in contact with the incoming filament is enlarged by the deflection and/or pressing-on element. The deflection and/or pressing-on element is preferably configured to deflect the filament such that at least 180°, preferably at least 190°, of an overall circumference of the winding spool unit are in contact with the filament. Smaller or greater loops of the winding spool unit which are generated by the deflection and/or pressing-on element, in particular loops of the winding spool unit which are enlarged in comparison with an embodiment without a deflection and/or pressing-on element, are of course likewise conceivable. Friction and/or adhesion of the filament with the winding spool unit can advantageously be increased as a result, with the result that, in particular, entrainment of the filament with the rotational movement of the winding spool unit and/or formation of the loop and/or clamping of the loop under the incoming filament can be facilitated/achieved/improved. In this case, the deflection and/or pressing-on element can be embodied as a rotatable element, e.g. as a deflection roller, or as a fixed (non-rotatable) element, e.g. as a deflection rod or a deflection mat. In the case of the embodiment as a fixed element, the filament sweeps over a surface of the deflection and/or pressing-on element. In the case of the embodiment as a rotatable element, the deflection and/or pressing-on element at least partially rotates along with a movement of the incoming filament. In particular, the deflection and/or pressing-on element embodied as a deflection and/or pressing-on roller is free of its own rotational drive. In particular, an axis of rotation of the deflection and/or pressing-on element embodied as a deflection and/or pressing-on roller is oriented so as to be at least substantially parallel to an axis of rotation of the winding spool unit. In particular, the deflection and/or pressing-on element is supported on a translational and/or pivoting device, by means of which the deflection and/or pressing-on element can be introduced at least temporarily into the intermediate region between the winding spool unit and the filament capturing unit. In particular, the translational and/or pivoting device comprises at least one at least pivotable and/or at least translatable support arm, on which the deflection and/or pressing-on element is mounted.

In addition, it is proposed that, in the initial filament winding step, when bringing the filament into contact with the winding spool unit, a part of the filament running between the winding spool unit and the filament capturing unit is pressed against the winding spool unit by a pivotably and/or displaceably supported deflection and/or pressing-on element. A high reliability of the filament winding can advantageously be achieved as a result (high “catching rates”). Adherence of the filament to the winding spool unit or friction of the filament with the winding spool unit can advantageously be increased. Carrying out of the initial filament winding step can advantageously be made possible as a result with a particularly large number of winding tubes made of different materials, in particular also with so-called “low-friction” winding tubes which have, e.g., a surface made of a polytetrafluoroethylene material. It can advantageously be achieved as a result that the second conveying speed of the filament is determined by the outer circumferential speed and/or the revolution speed of the winding spool unit. In particular, the speed of the incoming thread is first determined by the filament capturing unit until the winding spool unit is in sufficient contact with the incoming filament/the filament provided by the filament generating device upstream of the filament with respect to the filament capturing unit, with the result that the winding spool unit undertakes the determination of the entry speed. In particular, the deflection and/or pressing-on element, in particular the deflection and/or pressing-on roller, is supported in a resilient manner such that a longitudinal axis, in particular an axis of rotation, of the deflection and/or pressing-on element can be moved in the radial direction of the winding spool unit. An undesirable effect, such as, e.g., noise generation or a loss of contact, can advantageously be reduced as a result of an unevenness in a winding spool surface, in a winding tube surface, e.g., as a result of a seam or edge, such as an injection-molded separating burr. In particular, after carrying out the filament separating step, the deflection and/or pressing-on element is removed again from the winding spool unit. In particular, after carrying out the filament separating step, the deflection and/or pressing-on element is removed again from the intermediate region between the winding spool unit and the filament capturing unit.

In addition, it is proposed that, in the filament capturing step, for capturing the filament by the filament capturing unit, the filament which is provided, in particular in a freely suspended manner, is deflected in the direction of the filament capturing unit by a pivotably and/or displaceably supported deflection element. A high success rate of the filament capturing step can advantageously be achieved as a result. A high reliability of the capturing of the filament which is initially provided in a freely suspended manner can advantageously be achieved. In particular, the filament which is provided is deflected by the deflection element such that it comes into contact with the filament capturing unit, in particular with driven rotated filament capturing rollers of the filament capturing unit. In particular, the filament which is provided is deflected by the deflection element such that it is guided into an intermediate space between two filament capturing rollers of the filament capturing unit which rotate about axes of rotation which are oriented so as to be parallel to one another. The filament capturing rollers can be arranged with respect to one another such that grooves which are arranged on outer surfaces of the filament capturing rollers engage into one another in a gearwheel-like (but non-contacting) manner during the rotation of the filament capturing rollers.

Furthermore, it is proposed that, in at least one filament threading step which temporally follows the initial filament winding step, and in particular a filament separating step of the filament winding method, the filament which is wound onto the winding spool unit is threaded into a filament axial guide unit which forces a reciprocating movement of the incoming filament along an axial direction of the winding spool unit. A uniform winding of the successfully wound filament onto the winding spool unit can advantageously be achieved as a result. In this case, it is conceivable for the filament axial guide unit to thread at least two filaments which are wound simultaneously onto a single winding spool unit.

Furthermore, a filament winding device, in particular a glass fiber winding device, for filaments with a thickness of more than 68 tex, preferably for glass fiber direct rovings, in particular for carrying out the filament winding method, with at least one filament capture unit which is configured to capture the, in particular freely hanging, provided, in particular generated, filament, to generate at least one tensile force on the filament and to convey the filament at a first conveying speed, with the rotatable winding spool unit which is configured to initially wind the captured filament, and with a deflection and/or pressing-on element which is provided to bring the filament already captured by the filament capture unit into contact upstream of the filament with the rotatable winding spool unit, such that a second conveying speed can be exerted on the captured filament during a rotation of the winding spool unit, wherein the first conveying speed and the second conveying speed are of different magnitudes, is proposed. An optimized filament winding of a new filament onto a winding spool unit can advantageously be achieved by the filament winding device according to the invention. A substantial independence from the necessity of operator interventions can advantageously be achieved. A particularly high degree of automation can advantageously be achieved.

In addition, a filament winding machine, in particular a glass fiber winding machine, which implements in particular the advantages of the filament winding device, with at least one of the filament winding devices, is proposed.

The filament winding method according to the invention, the filament winding device according to the invention and the filament winding machine according to the invention are not intended to be restricted here to the application and embodiment described above. In particular, the filament winding method according to the invention, the filament winding device according to the invention and the filament winding machine according to the invention can have a number of individual elements, components and units differing from a number mentioned herein in order to fulfill a functionality described herein.

### DRAWINGS

Further advantages result from the following description of the drawings. An exemplary embodiment of the invention is illustrated in the drawings. The drawings, the description and the claims contain numerous features in combination. The person skilled in the art will expediently also consider the features individually and combine them to form meaningful further combinations.

In the drawings:

FIG. 1 shows a schematic perspective illustration of a filament winding device of a filament winding machine in a first operating position of a filament winding method,

FIG. 2 shows the illustration of the filament winding device in a second operating position of the filament winding method,

FIG. 3 shows the illustration of the filament winding device in a third operating position of the filament winding method,

FIG. 4 shows the illustration of the filament winding device in a fourth operating position of the filament winding method,

FIG. 5 shows the illustration of the filament winding device in a fifth operating position of the filament winding method,

FIG. 6 shows the illustration of the filament winding device in a sixth operating position of the filament winding method,

FIG. 7 shows the illustration of the filament winding device in a seventh operating position of the filament winding method, and

FIG. 8 shows a schematic flow diagram of the filament winding method.

### DESCRIPTION OF THE EXEMPLARY EMBODIMENTS

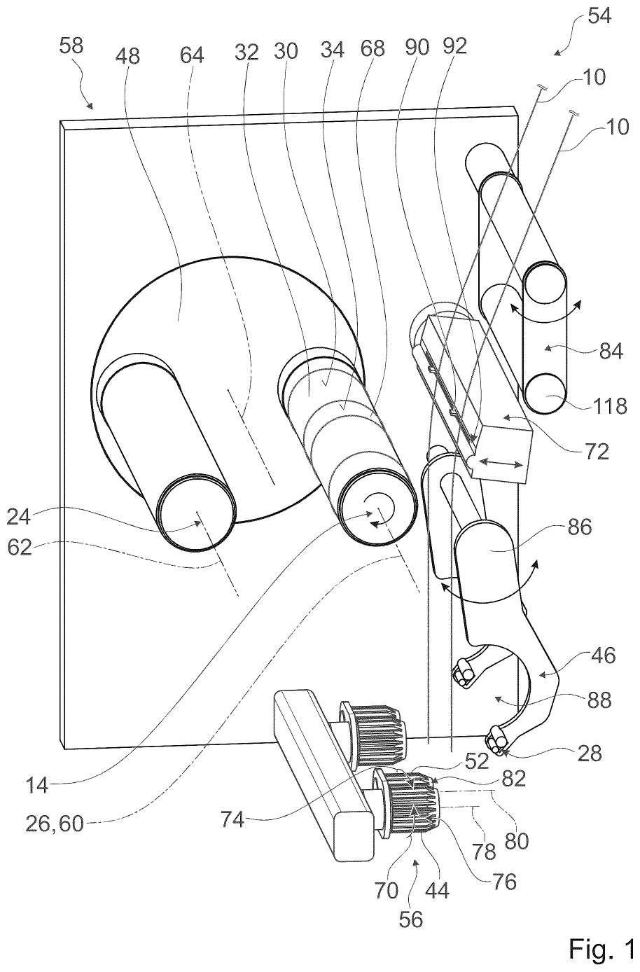

FIG. 1 schematically shows a part of a filament winding machine 58. The filament winding machine 58 is embodied as a glass fiber winding machine. The filament winding machine 58 has one or more filament winding devices 54. The filament winding device 54 of the filament winding machine 58 is illustrated by way of example in FIG. 1.

The filament winding device 54 is embodied as a glass fiber winding device. The filament winding device 54 is configured for winding filaments 10. The filaments 10 are embodied, for example, as glass fibers. The filaments 10 are embodied as glass fiber direct rovings. In the illustrated example, two filaments 10 are provided simultaneously by a filament generating device (not illustrated). The filaments 10 are provided in a freely suspended manner. The filament winding device 54 is configured for generating wound filament winding packages. The glass fiber winding device is configured for generating wound glass fiber winding packages. The filament winding device 54 is configured for filaments 10 with a thickness of more than 68 tex. The filament winding device 54 is optimized for winding and transferring glass fibers with a thickness between 900 tex and 10,000 tex. The filament winding device 54 is configured for carrying out a filament winding method illustrated in the figures.

The filament winding device 54 has a winding spool unit 14. The winding spool unit 14 is supported so as to be rotatable about an axis of rotation 60 running parallel to a longitudinal axis of the winding spool unit 14. The filament winding device 54 has a further winding spool unit 24. The further winding spool unit 24 is supported so as to be rotatable about an axis of rotation 62 running parallel to a longitudinal axis of the further winding spool unit 24. The winding spool units 14, 24 are configured for winding the filament 10 by rotation about the axes of rotation 60, 62 thereof. In the illustrated case, two winding tubes 32 are applied by way of example onto the winding spool unit 14. The winding tubes 32 are embodied as hollow cylinders which can be fitted onto the winding spool units 14, 24. The winding tubes 32 each have a winding surface 30. The winding surfaces 30 of the winding tubes 32 are embodied from a winding surface material which assists entrainment of a filament 10 coming into contact with the winding surface 30. For example, the winding surface material of the winding tube 32 in FIG. 1 is a cardboard. Alternative winding surface materials of winding tubes 32 are conceivable. Alternatively or additionally, the winding tubes 32 can each have a special topographical winding surface property of the winding surface 30. The topographical winding surface property of the winding surface 30 of the winding tubes 32 is embodied such that entrainment of a filament 10 coming into contact with the winding surface 30 is assisted. For example, the winding surface 30 of the winding tube 32 in FIG. 1 has a topographical winding surface property which is distinguished by a particular roughness. Alternative topographical winding surface properties of winding tubes 32 are conceivable.

The winding spool unit 14 optionally has a catching ring 68. Configurations of the winding spool unit 14 without a catching ring 68 are likewise conceivable. The catching ring 68 is arranged approximately halfway along the axial length of the winding spool unit 14. The catching ring 68 surrounds an entire circumference of the winding spool unit 14. In each case, a winding tube 32 is arranged on both sides of the catching ring 68 in the axial direction 26 of the winding spool unit 14. The catching ring 68 is arranged laterally next to the winding surface 30 of the winding tube 32. The catching ring 68 is configured to exert a substantially increased friction or adhesion with the filament 10 in comparison with a surface of a filament winding package wound onto a winding spool unit 14, 24. For this purpose, the catching ring 68 has a catching surface 34. The catching surface 34 of the catching ring 68 is embodied from a winding surface material which assists entrainment of a filament 10 coming into contact with the catching surface 34. For example, the winding surface material of the catching ring 68 in FIG. 1 is an aluminum. Alternative winding surface materials of catching rings 68 are conceivable. Alternatively or additionally, the catching rings 68 can each have a special topographical winding surface property of the catching surface 34. The topographical winding surface property of the catching surface 34 of the catching ring 68 is embodied such that entrainment of a filament 10 coming into contact with the catching surface 34 is assisted. For example, the catching surface 34 of the catching ring 68 in FIG. 1 has a topographical winding surface property which is distinguished by a particularly pronounced smoothness. Alternative topographical winding surface properties of catching rings 68 are conceivable. The filament winding device 54 has a rotary plate 48. The rotary plate 48 is supported so as to be rotatable about a central axis of rotation 64. The winding spool units 14, 24 are arranged eccentrically on the rotary plate 48.

The filament winding device 54 has a filament catching unit 56. The filament catching unit 56 is configured to catch the provided filament 10. The filament catching unit 56 is configured to generate a tensile force 66 on the captured filament 10. The filament catching unit 56 is configured to convey the filament 10 at a first conveying speed. The filament catching unit 56 comprises in each case two filament capturing rollers 44, 52 per filament 10 which is to be captured. The filament capturing rollers 44, 52 are rotatable in opposite directions 70, 74. The filament capturing rollers 44, 52 have groove-like furrows 76 on the outer circumference. The furrows 76 extend parallel to axes of rotation 78, 80 of the filament capturing rollers 44, 52. On a side which faces the filament 10 which is provided in a suspended manner, the filament capturing rollers 44, 52 each have a capturing bevel 82. The capturing bevel 82 is embodied as a conical run-in/as a bevel of an end, pointing in the direction of the filament 10, of the filament capturing roller 44, 52. The rotatable winding spool unit 14 is configured to initially wind the filament 10, in particular captured by the filament capturing unit 56. The winding spool unit 14 is configured to convey the initially wound filament 10/a filament 10 coming into contact with the winding surface 30 at a second conveying speed.

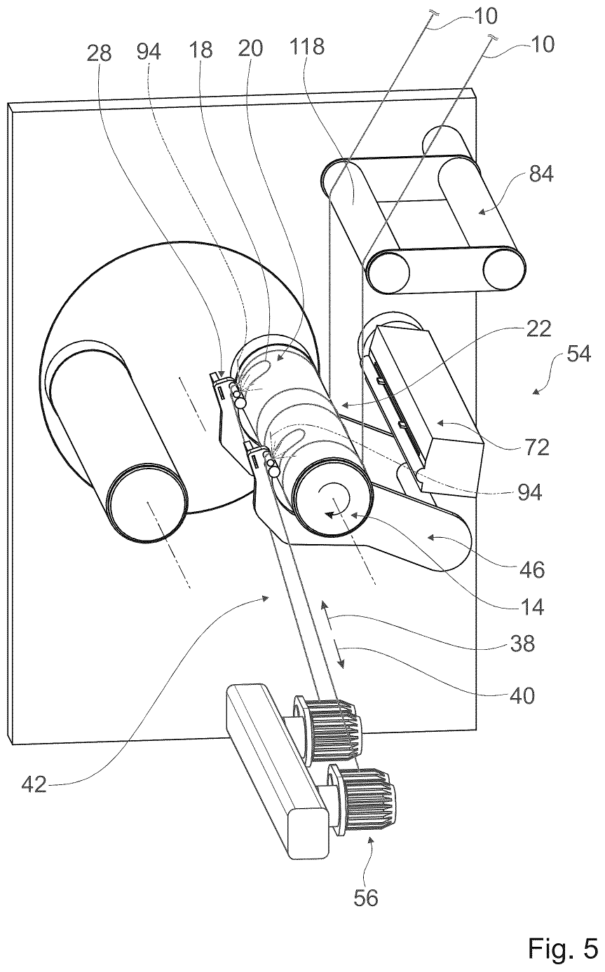

The first conveying speed and the second conveying speed are of different magnitudes. The second conveying speed is greater than the first conveying speed. A ratio of the conveying speeds is selected such that, when bringing the filament 10 captured by the filament capturing unit 56 into contact with the winding spool unit 14, a filament tension between the winding spool unit 14 and the filament capturing unit 56 is reduced. The ratio of the second conveying speed and the first conveying speed is at least 1.01, preferably at least 1.02 and preferably at least 1.03. The ratio of the second conveying speed and the first conveying speed is at most 5, preferably at most 4 and preferably at most 3.5. The ratio of the second conveying speed and the first conveying speed is selected such that, as a result of the contact with the winding spool unit 14 and as a result of the rotational movement of the winding spool unit 14, the filament 10 forms a loop 18 (cf. also FIG. 5). The loop 18 forms an arc 20. The arc 20 of the loop 18 points in the direction of an entry point 22 of the winding spool unit 14 (cf. also FIG. 5). At the entry point 22, the filament 10 provided by a filament generating device (not illustrated) meets the winding spool unit 14.

The filament winding device 54 has a deflection and/or pressing-on element 46. The deflection and/or pressing-on element 46 is configured to bring the filament 10 already captured by the filament capturing unit 56 into contact with the rotatable winding spool unit 14 upstream of the filament. As a result of bringing the filament 10 into contact with the winding spool unit 14, the second conveying speed can be exerted on the captured filament 10 during the rotation of the winding spool unit 14. The deflection and/or pressing-on element 46 is configured to deflect the part of the filament 10 running between the winding spool unit 14 and the filament capturing unit 56 when bringing the filament 10 into contact with the winding spool unit 14. The deflection and/or pressing-on element 46 is configured to press the part of the filament 10 running between the winding spool unit 14 and the filament capturing unit 56 against the winding spool unit 14 when bringing the filament 10 into contact with the winding spool unit 14. The deflection and/or pressing-on element 46 is supported in a pivotable manner. The deflection and/or pressing-on element 46 has a pivot arm 86. The deflection and/or pressing-on element 46 has an encompassing recess 88. The encompassing recess 88 is configured to encompass an outer circumference of the winding spool unit 14 at least by 120°, preferably by approximately 180°. The filament winding device 54 has a deflection element 84. The deflection element 84 is embodied separately from the deflection and/or pressing-on element 46. Alternatively, the deflection element 84 can also be embodied jointly or in one piece with the deflection and/or pressing-on element 46. The deflection element 84 is supported in a pivotable manner. The deflection element 84 has a cantilever 118. The cantilever 118 can be brought into contact with the filament 10 by the pivoting of the deflection element 84. The cantilever 118 moves the filament 10 in a manner dependent on a set pivoting angle toward the filament capture unit 56 or away from the filament capture unit 56. The deflection element 84 is configured to deflect the filament 10 which is provided in a suspended manner in the direction of the filament capture unit 56.

The filament winding device 54 has a filament axial guide unit 72. The filament axial guide unit 72 is configured to force a reciprocating movement of the incoming filament 10 along the axial direction 26 of the winding spool unit 14. The filament axial guide unit 72 is configured to generate planar filament winding layers on the winding spool unit 72. The filament axial guide unit 72 has a threading element 90. The threading element 90 is configured to laterally contact and/or thread in the filament 10. The threading element 90 is configured to carry along the filament 10 with a reciprocating movement of the threading element 90. The filament axial guide unit 72 has a linear guide rail 92. The threading element 90 is movable to and fro along the linear guide rail 92.

The filament winding device 54 has a supporting device for supporting the formation of the loop 18 which is important for the filament winding method. The filament winding device 54 has a blowing device 28. The supporting device is formed by the blowing device 28. The blowing device 28 is configured for directionally outputting a gas flow 94, preferably an air flow. Alternatively or additionally to the blowing device 28, the filament winding device 54 can have a spraying device. The spraying device can then be configured for directionally outputting a liquid. The blowing device 28 and/or the spraying device is configured to assist, in particular to accelerate, the formation of the loop 18 and/or to increase the extent thereof in the direction of the entry point 22. The blowing device 28 is configured to output a gas flow 94 which is directed in the direction of the entry point 22. The blowing device 28 is configured to blow the gas flow 94 into an opening of the loop 18. The blowing device 28 is configured to blow the gas flow 94 onto an inner side of the arc 20 of the loop 18. The alternative or additional spraying device can have the same object and/or an additional object of applying an adhesion-promoting liquid to the winding spool unit 14. As illustrated by way of example in the figures, the deflection and/or pressing-on element 46 can be embodied in a common component with the blowing device 28 and/or with the spraying device. Alternatively, however, the deflection and/or pressing-on element 46 can also be embodied as a component which is separate therefrom.

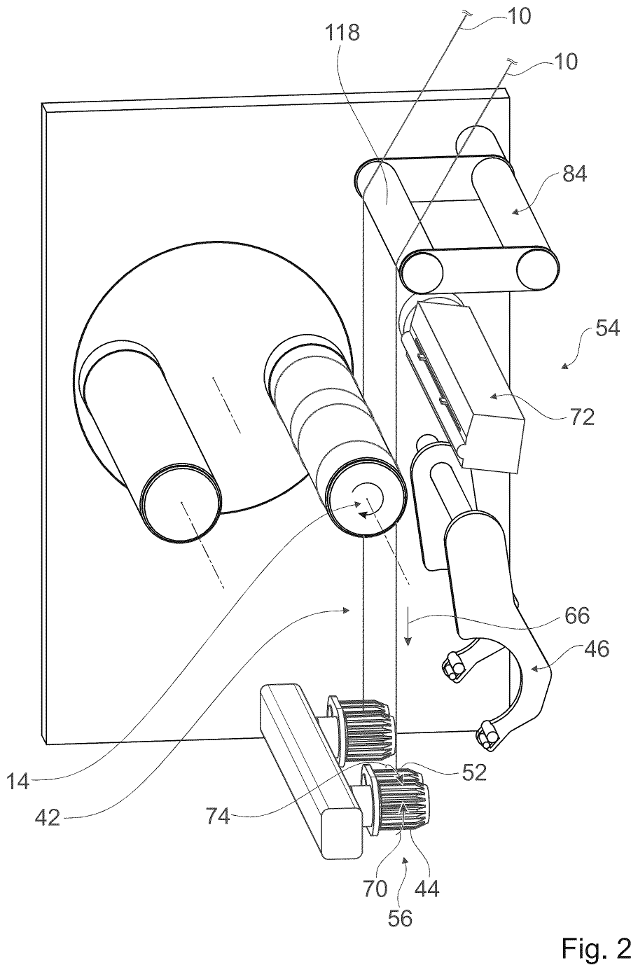

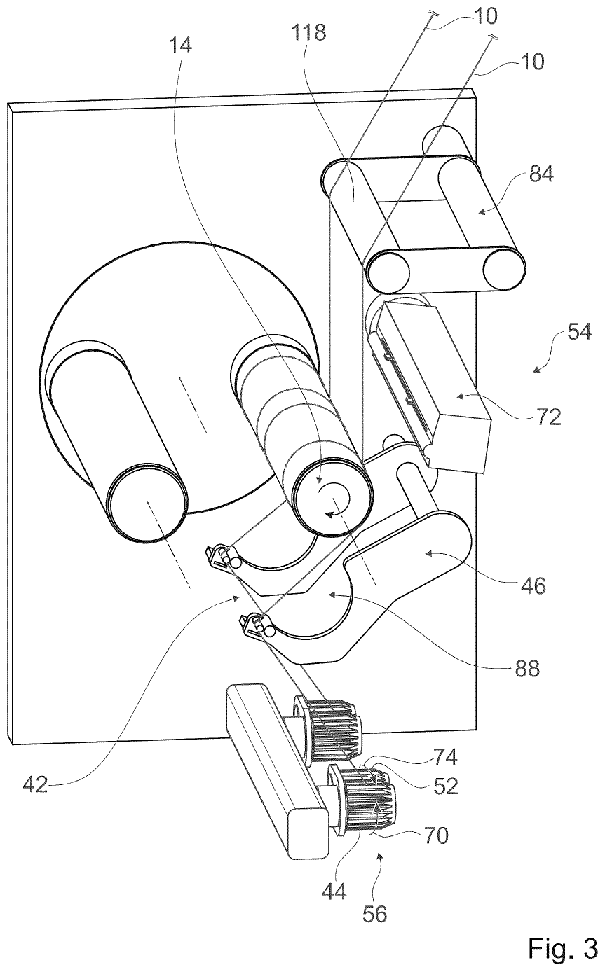

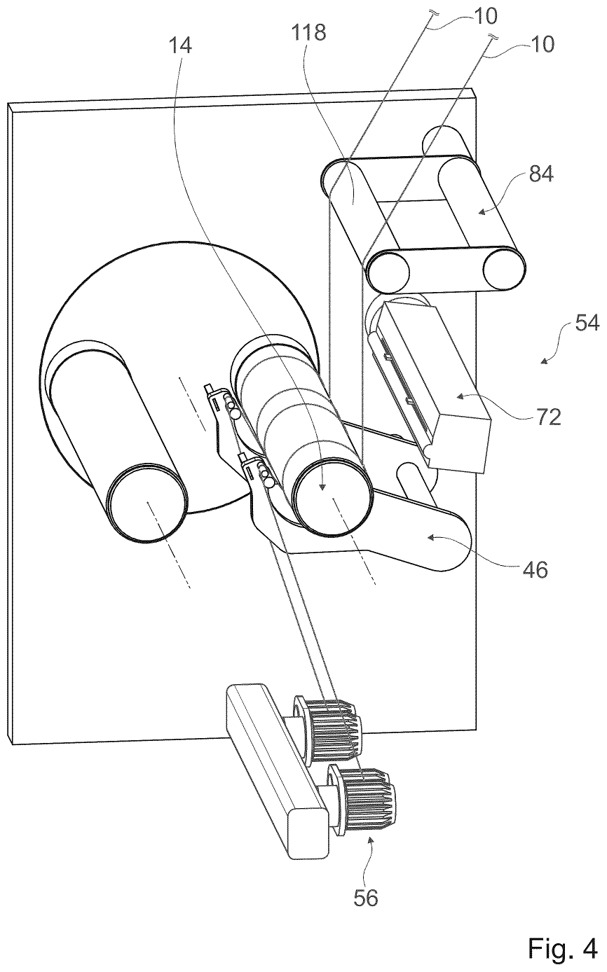

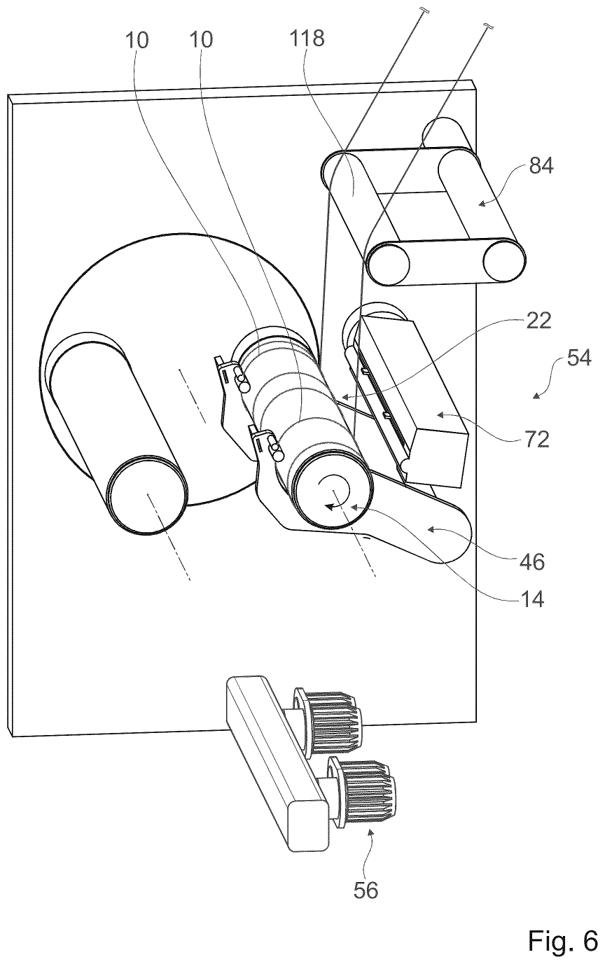

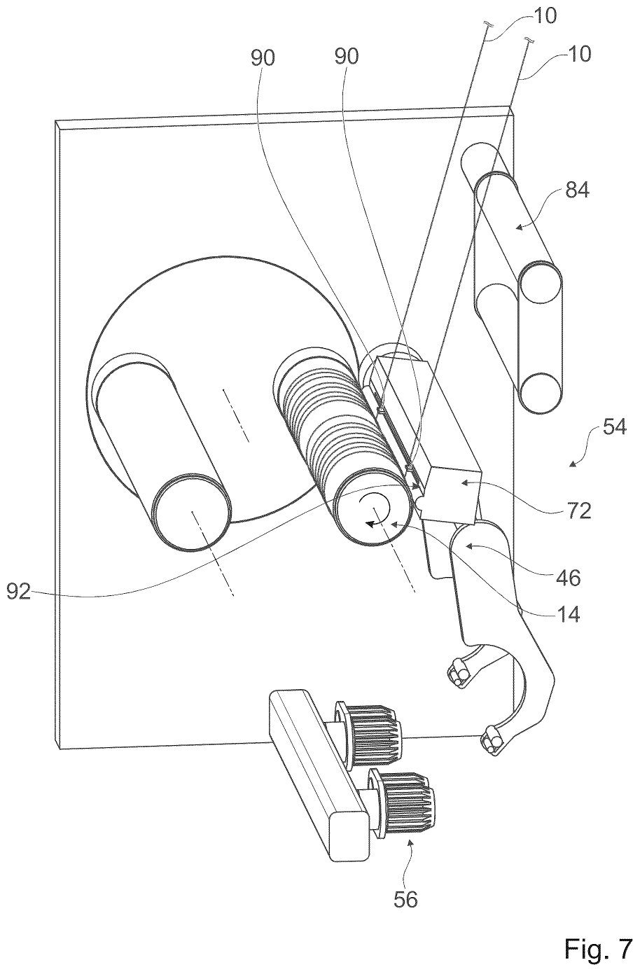

FIGS. 1 to 7 schematically show the filament winding device 54 in different time periods of the filament winding method. FIG. 1 shows the situation in which the filament 10 is provided in a suspended manner. FIG. 2 shows the situation in which the deflection element 84 is pivoted such that the filament 10 is pushed between the filament capturing rollers 44, 52 of the filament capturing unit 56. FIG. 3 shows the situation in which the deflection and/or pressing-on element 46 deflects the filament 10 in an intermediate region 42 between the winding spool unit 14 and the filament capturing unit 56 in the direction of the winding spool unit 14. FIG. 4 shows the situation in which the deflection and/or pressing-on element 46 presses the filament 10 against the winding spool unit 14. FIG. 5 shows the situation in which the loop 18 is produced. The production of the loop 18 can be assisted by the blowing device 28. FIG. 6 shows the situation in which the loop 18 is already captured and clamped by the incoming part of the filament 10. As a result, a tension is generated in the intermediate region 42 in a direction of tension 38 pointing toward the winding spool unit 14 (cf. FIG. 5), while the filament capturing unit 56 draws in a direction of tension 40 opposite the direction of tension 38. The tensile forces in the opposite directions of tension 38, 40 are increased further and further by the winding of the filament 10 onto the winding spool unit 14 until that part of the filament 10 which is arranged in the intermediate region 42 tears. FIG. 7 shows the situation in which the filament 10 is separated from the filament capturing unit 56 and only the winding spool unit 14 is wound with the filament 10. During the winding of the winding spool unit 14 with the filament 10, the filament axial guide unit 72 moves the filament 10 in an oscillating manner along the axial direction 26 of the winding spool unit 14. The deflection and/or pressing-on element 46 and the deflection element 84 are each pivoted back into their starting positions/rest positions again.

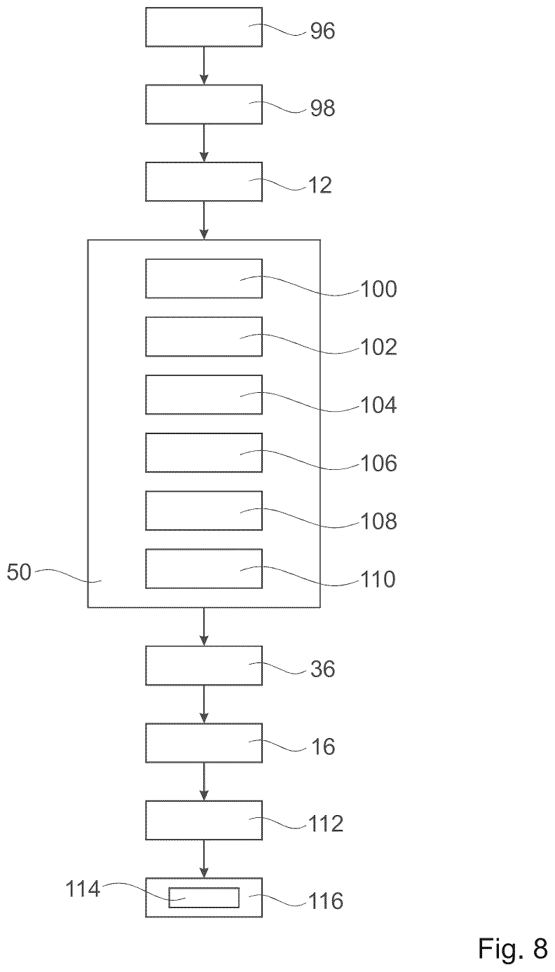

FIG. 8 shows a schematic flow diagram of the filament winding method for filaments 10 with a thickness of more than 68 tex. The filament winding method forms a glass fiber winding method for glass fibers, in particular for glass fiber direct rovings. In at least one filament production step 96, in particular not representing part of the filament winding method, the filament 10 is produced from a preform. In at least one provision step 98, the produced filament 10 is provided in a freely suspended manner (cf. FIG. 1). In at least one filament capture step 12, the provided filament 10 is captured by the filament capturing unit 56. For this purpose, the filament 10 is deflected by a pivoting of the deflection element 84 by the deflection element 84 in the direction of the filament capturing unit 56, in particular in the direction of a capture space of the filament capturing unit 56 which lies between the filament capturing rollers 44, 52 (cf. FIG. 2). The filament capturing unit 56, in particular the rotated filament capturing rollers 44, 52, generate a tensile force 66 on the filament 10. The filament capturing unit 56, in particular the rotated filament capturing rollers 44, 52, convey the filament 10 at the first conveying speed.

In at least one initial filament winding step 50 which temporally follows the filament capture step 12, the filament 10 to be wound/captured is initially wound onto the winding spool unit 14. For this purpose, in a first substep 100 of the initial filament winding step 50, the filament 10 already captured by the filament capturing unit 56 is brought into contact with the rotated winding spool unit 14 upstream of the filament. In at least one substep 108 of the initial filament winding step 50, for supporting the bringing of the filament 10 into contact with the winding spool unit 14, the incoming part of the filament 10 and/or the part of the filament 10 running between the winding spool unit 14 and the filament capturing unit 56 is deflected in the direction of the winding spool unit 14 by the pivotably and/or displaceably supported deflection and/or pressing-on element 46. In at least one further substep 110 of the initial filament winding step 50, for supporting the entrainment of the filament 10 with the winding spool unit 14 at the second conveying speed, the part of the filament 10 running between the winding spool unit 14 and the filament capturing unit 56 is pressed against the winding spool unit 14 by the pivotably and/or displaceably supported deflection and/or pressing-on element 46.

As a result of bringing the filament 10 into contact with the rotated winding spool unit 14, the second conveying speed is exerted on the captured filament 10 at the contact point of the filament 10 with the winding spool unit 14 by the rotation of the winding spool unit 14. The first conveying speed and the second conveying speed are of different magnitudes. As a result of the contact of the filament 10 with the winding spool unit 14, the filament 10 is entrained at least in sections with the rotational movement of the winding spool unit 14. The ratio of the second conveying speed and the first conveying speed is selected in the substep 100 such that, as a result of the contact and as a result of the rotational movement of the winding spool unit 14, the filament 10 forms the loop 18 whose arc 20 points in the direction of the entry point 22 of the winding spool unit 14. In at least one further substep 102 of the initial filament winding step 50, the formation of the loop 18 is assisted by the blowing device 28 and/or by the spraying device. In at least one further substep 104 of the initial filament winding step 50, the formation of the loop 18 is assisted by the choice of a winding surface material and/or the topographical winding surface property of the winding surface 30 of the winding spool unit 14. In at least one further substep 106 of the initial filament winding step 50, the loop 18 is enlarged so far in the direction of the entry point 22 that the loop 18 falls under the incoming filament 10. In at least one further substep 108 of the initial filament winding step 50, the loop 18 is clamped by the incoming filament 10.

In at least one filament separating step 36 which temporally follows the initial filament winding step 50, the clamped and/or wound filament 10 is separated in the intermediate region 42 on account of different directions of tension 38, 40 on the filament 10 in the intermediate region 42 between the winding spool unit 14 and the filament catching unit 56. In the filament separating step 36, the filament 10 is preferably torn. However, active separating assistance by cutting may also be present. In at least one filament threading step 16 which temporally follows the initial filament winding step 50 and the filament separating step 36, the filament 10 which is wound onto the winding spool unit 14 is threaded into the filament axial guide unit 72. In at least one further method step 112, the filament 10 is wound onto the winding spool unit 14 in order to form a filament winding package. In at least one further method step 116, a further filament winding method is carried out, which comprises a filament transfer step 114, in which the filament 10 to be wound is transferred from the winding spool unit 14 to the further winding spool unit 24 or vice versa. The further filament winding method is described in detail in a German patent application with the application number 10 2022 131 742.0.

1. A filament winding method for filaments with a thickness of more than 68 tex, with at least one filament capture step, in which the provided, filament is captured by a filament capturing unit, which generates at least one tensile force on the filament and conveys the filament at a first conveying speed, and with at least one initial filament winding step, in which the filament to be wound is initially wound onto a winding spool unit, wherein in the initial filament winding step, the filament already captured by the filament capturing unit is brought into contact upstream of the filament with the rotated winding spool unit, such that a second conveying speed is exerted on the captured filament by the rotation of the winding spool unit, wherein the first conveying speed and the second conveying speed are of different magnitudes, wherein a ratio of the second conveying speed and the first conveying speed is selected such that, as a result of the contact and as a result of the rotational movement of the winding spool unit, the filament forms a loop whose arc points in the direction of an entry point of the winding spool unit at which the incoming filament/the filament provided by a filament generating device meets the winding spool unit.

2. The filament winding method according to claim 1, wherein the second conveying speed is greater than the first conveying speed.

3. The filament winding method according to claim 1, wherein a ratio of the conveying speeds is selected such that, when bringing the filament into contact with the winding spool unit, a filament tension between the winding spool unit and the filament capturing unit is reduced.

4. The filament winding method according to claim 1, wherein a ratio of the second conveying speed and the first conveying speed is at least 1.01.

5. The filament winding method according to claim 4, wherein a ratio of the second conveying speed and the first conveying speed is at most 5.

6. (canceled)

7. The filament winding method according to claim 1, wherein the formation of the loop is assisted by a blowing device and/or by a spraying device.

8. The filament winding method according to claim 1, wherein the formation of the loop is assisted by a choice of a winding surface material and/or a topographical winding surface property of a winding surface of the winding spool unit, of a winding surface of a winding tube fitted onto the winding spool unit or of a catching surface of the winding spool unit arranged laterally next to the winding surface of the winding spool unit or of the winding tube.

9. The filament winding method according to claim 1, wherein the loop extends so far in the direction of the entry point that the loop falls under the incoming filament/the filament provided by the filament generating device and is clamped by the incoming filament/the filament provided by the filament generating device.

10. The filament winding method according to claim 1, wherein in at least one filament separating step following the initial filament winding step, the initially wound filament is separated, in the intermediate region.

11. The filament winding method according to claim 1, wherein in the initial filament winding step, when bringing the filament into contact with the winding spool unit, an incoming part of the filament and/or a part of the filament running between the winding spool unit and the filament capturing unit is deflected in the direction of the winding spool unit by a pivotably and/or displaceably supported deflection and/or pressing-on element.

12. The filament winding method according to claim 1, wherein in the initial filament winding step, when bringing the filament into contact with the winding spool unit, a part of the filament running between the winding spool unit and the filament capturing unit is pressed against the winding spool unit by a pivotably and/or displaceably supported deflection and/or pressing-on element.

13. The filament winding method according to claim 1, wherein in the filament capturing step, for capturing the filament by the filament capturing unit, the filament which is provided, is deflected in the direction of the filament capturing unit by a pivotably and/or displaceably supported deflection element.

14. The filament winding method according to claim 1, wherein in at least one filament threading step which temporally follows the initial filament winding step, the filament which is wound onto the winding spool unit is threaded into a filament axial guide unit which forces a reciprocating movement of the incoming filament along an axial direction of the winding spool unit.

15. A filament winding device, for filaments with a thickness of more than 68 tex, for carrying out a filament winding method according to claim 1, comprising:
at least one filament capturing unit which is configured to capture the provided filament, to generate at least one tensile force on the filament and to convey the filament at a first conveying speed,
at least one rotatable winding spool unit which is configured to initially wind the captured filament, and
a deflection and/or pressing-on element which is configured to bring the filament already captured by the filament capturing unit into contact upstream of the filament with the rotatable winding spool unit, such that a second conveying speed can be exerted on the captured filament during a rotation of the winding spool unit,
wherein the first conveying speed and the second conveying speed are of different magnitudes, wherein a ratio of the second conveying speed and the first conveying speed is selected such that, as a result of the contact and as a result of the rotational movement of the winding spool unit, the filament forms a loop whose arc points in the direction of an entry point of the winding spool unit at which the incoming filament/the filament provided by a filament generating device meets the winding spool unit.

16. A filament winding machine comprising at least one filament winding device according to claim 15.
